(19) United States
(12) Patent Application Publication
(10) Pub. No.: US 2025/0156804 A1
(43) Pub. Date: May 15, 2025

(54) SYSTEMS AND METHODS FOR ADVANCED INVENTORY CONTROL AUTOMATION

(71) Applicant: State Farm Mutual Automobile Insurance Company, Bloomington, IL (US)

(72) Inventors: Aaron Williams, Congerville, IL (US); Seth L. Corin, Cumming, GA (US)

(21) Appl. No.: 18/903,507

(22) Filed: Oct. 1, 2024

Related U.S. Application Data
(60) Provisional application No. 63/598,400, filed on Nov. 13, 2023.

(51) Int. Cl. G06Q 10/087

(52) U.S. Cl. CPC G06Q 10/087

(57) ABSTRACT

A computer system for vendor negotiation and analysis may be provided. The computer system may be programmed to (i) store a negotiation analysis model for analyzing and facilitating negotiations; (ii) receive a request for a product or service to be provided by a vendor; (iii) analyze a plurality of data for each of a plurality of vendors to determine a ranking of vendors for responding to the request; (iv) determine one or more vendors to contact based upon the ranking of vendors; (v) schedule a meeting with the one or more vendors; (vi) monitor each meeting with the one or more vendors; (vii) generate a recommendation for a vendor to respond to the request based upon the meeting and information about the vendor; and/or (viii) in response to receiving a decision to approve the vendor, generate one or more documents to transmit to the vendor.

### CROSS-REFERENCE TO RELATED APPLICATIONS

This application claims priority to U.S. Provisional Application No. 63/598,400, filed on Nov. 13, 2024, the entire contents and disclosure of which are hereby incorporated herein by reference in its entirety.

### FIELD OF THE DISCLOSURE

The present disclosure relates to advance inventory control automation, and more particularly, to a network-based system and method for analyzing inventory levels, determining needs, coordinating purchase processes, and analyzing and updating procedures.

### BACKGROUND

Corporations or other business entities may generally like to maintain a minimal inventory of needed products. When these entities require additional materials not in inventory, or additional vendors for supplying products and services, to help build solutions and/or form relationships to further the reach of the entity's brand, there are many actions that may be needed to be followed.

These actions may include Discovery, Assessment, and Recommendations. These actions may generally require the finding of quality vendors in the market who can facilitate, collaborate, or provide solutions, products, and services at scale. The actions may also include the coordination of initial meetings to understand product, service, capabilities, and relationships.

The actions may further include the assessment of Internal and External Risk. Assessing risk can be a long process and oftentimes includes very subjective information that could be based upon personal or market assumptions. As a result, companies may not actually know the objective risks involved with a project, either internal risks or external risks. Other actions may include, but are not limited to, non-disclosure agreement (NDA) creation, the evaluation of price, quality, scale and consistency, and/or contract creation and negotiation. This may be a repetitive process that may be required to be undertaken each time a need is identified.

Today the process of finding the right vendor with the right services, product availability at scale, and at the right price may be a long and involved process. The ultimate goal of this process may include finding the best quality vendor to supply the service or product, best consistency of the product or service, and at the lowest price.

However, it would be advisable to create a system for storing and retrieving information about different vendors and services to simplify the procedure of procuring goods and/or services. Conventional techniques may include additional drawbacks, inefficiencies, ineffectiveness, and/or encumbrances as well.

### BRIEF SUMMARY

The present embodiments may relate to, inter alia, a vendor negotiation and analysis tool, and more particularly, to a network-based system and network-based or computer-based method for analyzing inventory levels, determining needs, coordinating purchase processes, and/or analyzing and updating procedures. The systems and methods described herein may provide for automating the more time-consuming elements of the vendor negotiation process. These elements may include, but are not limited to, finding vendors who can fulfill at the required scale/quantities, assessing those vendors, understanding the risk variables of the vendors, non-disclosure agreement (NDA) contract creation, negotiation and renegotiation automation, payment for materials, solutions, and services, tracking of fulfillment, and/or rating of relationship for future negotiation.

In one aspect, a computer system configured to facilitate advanced inventory control automation may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (1) store a negotiation analysis model for analyzing and facilitating negotiations; (2) receive a request for a product or service to be provided by a vendor; (3) execute the negotiation analysis model to analyze the plurality of information for each of the plurality of vendors to determine a ranking of vendors for responding to the request; (4) execute the negotiation model to determine one or more vendors to contact based upon the ranking of vendors; (5) schedule a meeting with the one or more vendors; (6) monitor each meeting with the one or more vendors; (7) execute the negotiation model to generate a recommendation for a vendor to respond to the request based upon the meeting and information about the vendor; and/or (8) in response to receiving a decision to approve the vendor, generate one or more documents to transmit to the vendor. The computer system may include additional, less, or alternate functionality, including that discussed elsewhere herein.

In another aspect, a computer-implemented method for vendor negotiation and analysis and/or advanced inventory control automation may be provided. The computer-implemented method may be implemented via one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer-implemented method may be performed by a computer device including at least one processor in communication with at least one memory device. The method may include: (1) storing a negotiation analysis model for analyzing and facilitating negotiations; (2) receiving a request for a product or service to be provided by a vendor; (3) executing the negotiation analysis model to analyze a plurality of data for each of a plurality of vendors to determine a ranking of vendors for responding to the request; (4) executing the negotiation analysis model to determine one or more vendors to contact based upon the ranking of vendors; (5) setting-up a meeting with the one or more vendors; (6) monitoring each meeting with the one or more vendors; (7) executing the negotiation analysis model to generate a recommendation for a vendor to respond to the request based upon the meeting and information about the vendor; and/or (8) in response to receiving a decision to approve the vendor, generating one or more documents to transmit to the vendor. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store a negotiation analysis model for analyzing and facilitating negotiations; (2) receive a request for a product or service to be provided by a vendor; (3) execute the negotiation analysis model to analyze a plurality of data for each of a plurality of vendors to determine a ranking of vendors for responding to the request; (4) execute the negotiation analysis model to determine one or more vendors to contact based upon the ranking of vendors; (5) schedule a meeting with the one or more vendors; (6) monitor each meeting with the one or more vendors; (7) execute the negotiation analysis model to generate a recommendation for a vendor to respond to the request based upon the meeting and information about the vendor; and/or (8) in response to receiving a decision to approve the vendor, generate one or more documents to transmit to the vendor. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow diagram of an exemplary computer-based process for automated vendor negotiation and analysis, in accordance with at least one embodiment.

FIG. 2 illustrates a flow diagram of another exemplary computer-based process for automated vendor negotiation and analysis, in accordance with at least one embodiment.

FIG. 3 illustrates a flow diagram of an exemplary computer-implemented process for automated vendor negotiation and analysis, in accordance with at least one embodiment.

FIG. 4 illustrates an exemplary computer system for performing the processes shown in FIGS. 1 and 2.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present disclosure relates to, inter alia, advance inventory control automation, and more particularly, to a network-based system and method for analyzing inventory levels, determining needs, coordinating purchase processes, and/or analyzing and updating procedures. In one exemplary embodiment, the process may be performed by a vendor analysis and coordination (VAC) computer device. In the exemplary embodiment, the VAC computer device may be in communication with one or more client devices, one or more vendor systems, and one or more analysis models. As described below in further detail, the VAC computer system includes one or more needs and vendor analysis models that analyze the needs of a corporation, company, store, etc. and determine vendors that may resolve those needs both in the short term and the long term.

The process of finding and assessing vendors, risks, and contracts is fairly uniform. This disclosure describes using the VAC computer system to automate the more time-consuming elements of the process. These include, but are not limited to, finding vendors who can fulfill at the required scale/quantities, assessing those vendors, understanding the risk variables of the vendors, non-disclosure agreement (NDA) contract creation, negotiation and renegotiation automation, payment for materials, solutions, and services, tracking of fulfillment, and/or rating of relationship for future negotiation.

Accordingly, the VAC computer system may create a training model and enables large language models, such as GPT (Generative Pre-trained Transformers) models, to automate the discovery of and recommendations for vendors and relationships that enable products, services, and solutions delivery. Moreover, the VAC computer device executes the GPT model to automate risk assessment, NDA and contract creation, ongoing price negotiation and ongoing assessment of other vendors and services who could fulfill defined needs.

In the exemplary embodiment, the VAC computer system is configured to program the GPT model to understand prompts that indicate goals, strategies, needs, capabilities, and intended outcomes and that match up to in-market solutions, products, or companies who align and that could help develop solutions to those goals, strategies, needs, capabilities, and intended outcomes.

In some embodiments, the VAC computer system uses blockchain navigation to understand inventories in stock for one or multiple vendors. The VAC computer system may further be programmed to determine the inventory to be found, such as through analysis of the blockchain navigation. The VAC computer system may be in direct communication with one or more computer systems of the vendors being analyzed. The VAC computer system may then analyze the vendors based upon their current inventory, their ability to meet future demand, and their historical performance.

The VAC computer system may also be programmed to perform risk evaluation on the one or multiple vendors to determine the risk level for whether or not the one or multiple vendors will perform as needed.

In still further embodiments, the VAC computer system may use one or more GPT models to evaluate contracts. These contracts may be for materials, utilities, maintenance, services, company vehicles, real estate, employee benefits and worker's comp, miscellaneous vendors, etc. In some of these embodiments, the VAC computer system may also analyze the contracts by reviewing and analyzing the cost or the cost profile of the contracts, the terms of the contracts, and/or any risks associated with the contracts, for example.

In additional embodiments, the VAC computer system determines the sustainability of the contract and the vendor. How long can the contract with the vendor be sustained? How long can the vendor sustain meeting the terms of the contract(s)? The VAC computer system may also determine any accountability thresholds and/or resolutions open to the buyer.

In evaluating the vendors, the VAC computer system also analyzes the size of the corporation and the size of the vendor. The VAC computer system further determines the vendors ability to fulfill the contracts at scale. The VAC computer system may also find companies to be vendors based upon custom criteria, such as minority owned, start-ups, established, veteran owned, and/or any other customer criteria that the user desires.

In the exemplary embodiment, the VAC computer system is programmed to create one or more NDAs for the user corporation and the vendor(s). These NDAs may be created based upon historical NDAs that have been used by the corporation. The NDAs may include specific clauses that are important to the corporation. The VAC computer system tailors the NDAs to the products and/or services as well as the individual vendors. In the exemplary embodiment, the VAC computer system generates the NDA for review by one or more legal advisors of the corporation. The VAC computer system may also be able to generate one or more other documents, such as, but not limited to, contracts, requests for proposals (RFP), requests for bids, and/or any other document desired that may be generated from historical information of other copies of said documents.

In the exemplary embodiment, the VAC computer system is programmed to make recommendations for contract negotiation and to have a human approve or decline. In some embodiments, the VAC computer system may automatically negotiation and renegotiate one or more terms of the contracts with the vendors. In other embodiments, the VAC computer system may provide negotiation instructions and/or recommendations to one or more humans for their use as a part of negotiations.

In the exemplary embodiment, the VAC computer system is configured to monitor vendor pitch presentations to evaluate the vendor pitches looking for the right fit for goals, strategies, and outcomes. This includes the VAC computer system generating live prompts during a pitch to clarify how a solution matches or can meet goals, strategies, and outcomes. The prompts may be generated in real-time during the pitch presentation and then transmitted to one or more users attending the pitch presentation, such as by transmitting the prompts to their client devices (e.g., smartphones). Furthermore, the prompts may be to ask the vendor representatives about one or more questions about their product that have not been answered yet, about something that one of the vendor representatives said during the pitch presentation, and/or a clarification about information that may have been shown by the vendor representative (e.g., on their slides).

In some embodiments, the VAC computer system is able to communicate with vendors, such as via email and/or an application, to request information to assist with risk assessment or contract negotiation recommendations.

In the exemplary embodiment, the VAC computer system is configured to evaluate multiple vendors' pitch presentations and to make prioritized recommendations based upon the pitch presentations and other information, such as that provided by the vendor representatives.

In at least one embodiment, the VAC computer system trains the GPT model to negotiate based upon analysis of historical negotiation patterns. The GPT model then uses those patterns to further automate subsequent negotiations. In some of these embodiments, both the corporation and the vendor are both using GPT models for part and/or all of the negotiation process outlined herein. This may lead to GPT-to-GPT negotiations and contract fulfillment automation.

In the exemplary embodiment, the VAC computer system trains the GPT model to understand inventories at different vendors, to create contracts, orders, and payments, and to coordinate deliveries. In at least some embodiments, the VAC computer system may perform some or all of the above steps by accessing blockchains which include information about one or more of the vendors, their inventories, historical inventories of the corporation, and other information as needed. The VAC computer system executes the GPT models to evaluate and rate the vendors. The vendors may be rated on their own and their ability to provide the needed inventory and/or perform the needed services. The vendors may also be rated in comparison to other vendors.

In additional embodiments, the VAC computer system analyzes the results of contract negotiations that it conducted and analyzes the performance of the vendors associated with successful negotiations to retrain the GPT model(s). Furthermore, the VAC computer system may analyze the performance of the vendors in providing the request goods and services to assist in further training of the GPT model(s) to determine potential warning signs about vendors that did not perform well and attributes of vendors that performed well and/or exceeded expectations.

In some further embodiments, the VAC computer system generates recommendations for future negotiations with a contracted vendor based upon one or more iterations of the negotiation process. Furthermore, the VAC computer system may also be able to provide feedback to the vendors who were declined for their own information and potential improvement.

While the above describes using the systems and processes described herein for analyzing vendors and performing negotiations for a corporation, one having skill in the art would understand that these systems and methods may also be used for other entities, including, but not limited to, governmental departments, municipal entities, small businesses, individual stores, franchises, divisions, departments, and/or any other entity that needs to determine the optimal vendors for providing goods and/or services and for assistance with negotiations for the goods and/or services.

At least one of the technical problems addressed by this system may include: (i) improved accuracy of negotiation process; (ii) reduced time of negotiation process; (iii) automation of repetitive tasks in the negotiation process; (iv) improve analysis capabilities of the negotiation process; and/or (v) improved efficiency of the negotiation process.

A technical effect of the systems and processes described herein may be achieved by performing at least one of the following actions: a) store a negotiation analysis model for analyzing and facilitating negotiations; b) receive a request for a product or service to be provided by a vendor; c) execute the negotiation analysis model to analyze a plurality of data for each of a plurality of vendors to determine a ranking of vendors for responding to the request; d) execute the negotiation analysis model to determine one or more vendors to contact based upon the ranking of vendors; e) schedule a meeting with the one or more vendors; f) monitor each meeting with the one or more vendors; g) execute the negotiation analysis model to generate a recommendation for a vendor to respond to the request based upon the meeting and information about the vendor; h) in response to receiving a decision to approve the vendor, generate one or more documents to transmit to the vendor; i) receive the plurality of data about the plurality of vendors including a plurality of attributes of each of the plurality of vendors; j) receive the plurality of data from a computer device associated with the vendor; k) store a plurality of historical negotiation information about a plurality of past negotiations; l) train the negotiation analysis model with the plurality of historical negotiation information; m) monitor a first meeting with a first vendor of the one or more vendors; n) generate at least one question for the first vendor based upon the monitored first meeting; o) transmit the at least one question to a representative in the first meeting; p) transmit the at least one question while the meeting is occurring; r) schedule a meeting with a first vendor of the one or more vendors by communicating with at computer device associated with the first vendor to determine a date for the meeting; s) transmit a meeting invite to a first vendor for the meeting; t) generate an invite to the meeting based upon the request; u) the request includes information about at least one of goals, strategies, and outcomes for the product or service to be provided, and wherein the at least one processor is further programmed to determine the ranking of vendors for responding to the request based upon how the corresponding vendor will meet the at least one of goals, strategies, and outcomes for the product or service to be provided; v) monitor performance of a selected vendor providing the product or service; w) analyze the performance of the selected vendor; x) update the negotiation analysis model based upon the analysis of the performance of the selected vendor; y) select the vendor to respond to the request based upon the meeting and information about the vendor; z) generate a non-disclosure agreement for a selected vendor; aa) submit the non-disclosure agreement to the selected vendor; ab) receive an executed non-disclosure agreement from the selected vendor; ac) request private information from the selected vendor subsequent to receiving the executed non-disclosure agreement; ad) prepare a contract for the approved vendor to provide the product or service; ae) analyze one or more inventory levels of one or more products; af) generate the request for a product to be provided by the vendor based upon the one or more inventory levels; ag) information for the one or more inventory levels is stored in a blockchain structure; ah) generate a feedback report for at least one unselected vendor, wherein the feedback report includes information as to why the vendor was not selected; and ai) the feedback report includes one or more improvements for the vendor for subsequent negotiations.

### Exemplary Computer Process for Automated Vendor Negotiation and Analysis

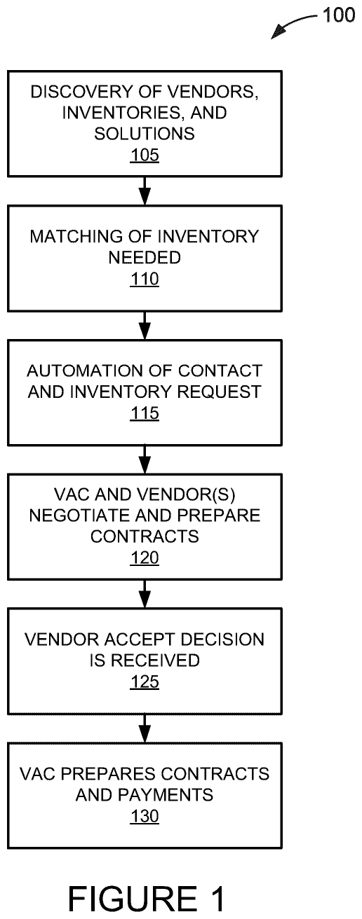

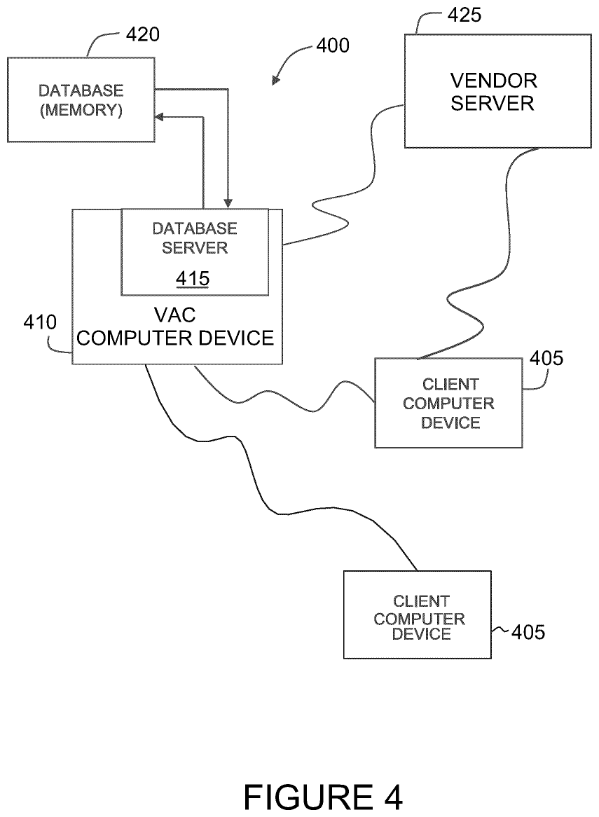

FIG. 1 illustrates a flow diagram of an exemplary computer-implemented process 100 for automated vendor negotiation and analysis, in accordance with at least one embodiment. In the exemplary embodiment, process 100 is performed by a vendor analysis and coordination (VAC) computer device 410 (shown in FIG. 4). In the exemplary embodiment, the VAC computer device 410 is in communication with at least one client device 405 and a plurality of vendor servers 425 (both shown in FIG. 4).

In the exemplary embodiment, the VAC computer device 410 performs 105 discovery of vendors, inventories, and solutions. The VAC computer device 410 trains one or more large language models, such as GPT (Generative Pre-trained Transformers) models, to understand how to search for and match vendors, inventories, and solutions to key goals, strategies, attributes, and outcomes for materials requests or for potential new products, services, and efficiencies. In some embodiments, the GPT model is trained to respond to a prompt, such as a user inquiring about the current inventory of pens on hand or a need for a new product or service. In other embodiments, the GPT model is trained to monitor current inventory levels of different goods, historical use rates and trends, and the performance of current and historical vendors of those goods. In these embodiments, the GPT model may continue on the steps of process 100 based upon the monitoring and analysis. For example, if an inventory of certain goods reaches a too low threshold, exceeds a too much threshold, and/or if there are any issues with the goods.

In some embodiments, the VAC computer device 410 trains different GPT models for different goods, different types of goods, different departments, different jurisdictions, and/or other divisions that the user desires.

In the exemplary embodiment, the VAC computer device 410 matches 110 the inventory needed. The VAC computer device 410 executes the trained GPT model to match desired materials and inventory from one or multiple sources either from known vendors, blockchain records, or new vendors. In some embodiments, the sources may include the vendors themselves, such as through websites and/or vendor servers 425. In some embodiments, information about the vendors and/or inventories is stored in blockchain records and/or other distributed ledgers. These blockchain records and/or distributed ledgers may be maintained by one or more of the vendors, vendor server 425 and/or the VAC computer device 410. The information about the vendors and/or inventories may include additional information, such as, but not limited to, current quantities of different goods, delivery terms, information about the vendors (such as employees, time to produce goods, etc.), ratings of the vendors, ratings of the goods, and/or other information as desired. The VAC computer device 410 evaluates the quantities of goods available and ratings of the vendors and/or the good. Based upon this evaluation, the VAC computer device 410 provides recommendation to the decision maker. In some embodiments, the VAC computer device 410 may automate one or more decisions based upon historical decisions made by the decision maker(s).

In the exemplary embodiment, the VAC computer device 410 automates 115 the contacting of vendors and the corresponding inventory request. Upon location of inventories with good quality and rating and upon acceptance from decision maker, the VAC computer device 410 executes a trained GPT model to prepare a communication to request materials and begin negotiation of cost as well as the contract with one or more matched vendors.

In the exemplary embodiment, the VAC computer device 410 begins 120 to negotiate with the vendors and begins to prepare contracts. The VAC computer device 410 executes the trained GPT model to automate negotiation. In some embodiments, the VAC computer device 410 provides points and comparisons for lower rates as a part of the negotiation. These points and comparisons may be provided to one or more users performing the negotiation. These points and comparisons may also be provided to the vendor(s) being negotiated with as counter points or other information to sway the vendor in the negotiation. In some of these embodiments, the VAC computer device 410 strategically negotiates if the outcome is to establish a longer-term relationship. Upon reaching an agreement with a vendor, the VAC computer device 410 prepares a contract for approval by vendor. In some embodiments, the contract is based upon previous contracts with similar vendors. The VAC computer device 410 tailors the contract for the desired vendor relationship. In some embodiments, the contract is a mixture of required clauses and/or limitations and tailored portions. In some of these embodiments, the VAC computer device 410 analyzed previous contracts and their corresponding vendor relationships and adjust the contracts based upon that information.

In the exemplary embodiment, the VAC computer device 410 receives 125 an accept decision from the decision maker. In response to the accept decision from the decision maker, the VAC computer device 410 prepares 130 the contracts and payments. The VAC computer device 410 executes the GPT models to prepare 130 one or more contracts based upon the intended inventories needed, as well as, the strategies, goals, pricing, terms, uses, and other outcomes. The VAC computer device 410 shares the contracts with the vendor for negotiation. The VAC computer device 410 receives the vendor response(s) to the contracts. Then the VAC computer device 410 executes the GPT models to adjust the contract(s) based upon the response. The VAC computer device 410 repeat this process until all parties agree. Once agreement is reached, the VAC computer device coordinates bills of lading, contract signatures, and payment fulfillment. Once complete, the VAC computer device 410 also tracks end fulfillment. In some embodiments, the VAC computer device 410 analyzes each step of the process and provides a rating for the vendor based upon how well each step of the process was navigated and the vendor's willingness to negotiate.

### Exemplary Computer Process for Automated Vendor Negotiation and Analysis

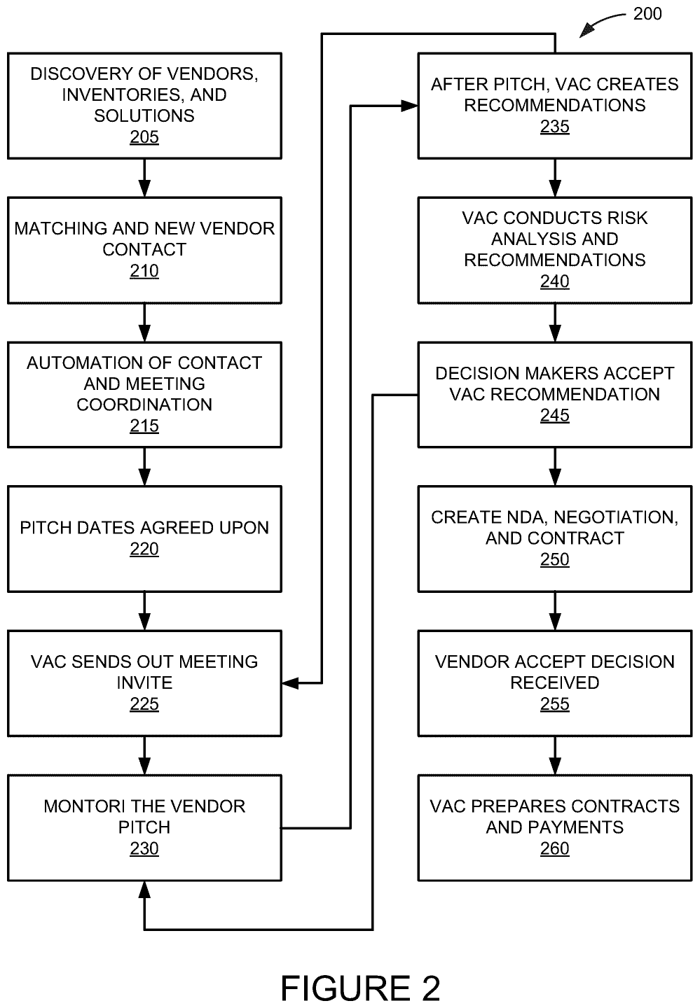

FIG. 2 illustrates a flow diagram of another exemplary computer-implemented process 200 for automated vendor negotiation and analysis, in accordance with at least one embodiment. In the exemplary embodiment, process 100 is performed by a vendor analysis and coordination (VAC) computer device 410 (shown in FIG. 4). In the exemplary embodiment, the VAC computer device 410 is in communication with at least one client device 405 and a plurality of vendor servers 425 (both shown in FIG. 4).

In the exemplary embodiment, the VAC computer device 410 performs 205 discovery of vendors, inventories, and solutions. The VAC computer device 410 trains one or more large language models, such as GPT (Generative Pre-trained Transformers) models, to understand how to search for and match vendors, inventories, and solutions to key goals, strategies, attributes, and outcomes for materials requests or for potential new products, services, and efficiencies. In some embodiments, the GPT model is trained to respond to a prompt, such as a user inquiring about the current inventory of pens on hand or a need for a new product or service. In other embodiments, the GPT model is trained to monitor current inventory levels of different goods, historical use rates and trends, and the performance of current and historical vendors of those goods. In these embodiments, the GPT model may continue on the steps of process 100 based upon the monitoring and analysis. For example, if an inventory of certain goods reaches a too low threshold, exceeds a too much threshold, and/or if there are any issues with the goods.

In some embodiments, the VAC computer device 410 trains different GPT models for different goods, different types of goods, different departments, different jurisdictions, and/or other divisions that the user desires.

In the exemplary embodiment, the VAC computer device 410 performs 210 matching and net vendor contact. The VAC computer device 410 executes a trained GPT model to match desired criteria from internet, blockchain, and known vendors. The VAC computer device 410 creates a prioritized recommendation and receives an accept or deny from the decision maker. In some further embodiments, the VAC computer device 410 automates the decision based upon the recommendation. In some embodiments, the VAC computer device 410 analyzes the different vendors and determines one or more vendors to recommend. The recommendation may be based upon rankings, past performance, current inventory, and/or other features of the vendors matching the desires of the user.

In the exemplary embodiment, the VAC computer device 410 performs 215 automated contact and meeting coordination. Upon accept decision of prioritized vendors, the VAC computer device 410 executes an advanced GPT chat model to prepare a communication to request a pitch presentation from the prioritized vendors. The VAC computer device 410 coordinates meeting dates with one or more users and one or more vendor representatives. In some embodiments, the VAC computer device 410 is in communication with one or more vendor servers 425 to schedule the meeting dates. In some of these embodiments, the VAC computer device 410 determines a range of dates and times with availability for one or more vendor representatives and one or more users/decision makers.

Once the pitch presentation dates are agreed upon 220, the VAC computer device 410 sends 225 out meeting invites. The meeting invite request that one or more vendor representatives conduct a pitch presentation to the one or more users/decision makers to present the advantages of using the vendor's products and/or services. The pitch presentation is also coordinated to allow the users/decision makers to ask questions. The invites may be transmitted via email, text messages, push notifications, calendar invites, automated voice calls, and/or any other method desired. In some embodiments, the meeting invite includes the description of the goods or services needed, the purpose of purchasing the good or service, one or more objectives of the buyer, and the buyer's intended outcomes.

In the exemplary embodiment, the VAC computer device 410 monitors 230 the vendor pitch presentation. The VAC computer device 410 along with one or more human representatives evaluates the pitch presentation. As the pitch presentation occurs, the VAC computer device 410 executes one or more GPT models to take notes. The VAC computer device 410 also provides or prompts questions as they pertain to the intended strategies, goals, and outcomes. In real-time during the pitch presentation, the VAC computer device 410 may determine one or more questions to pose to the vendor representative(s) conducting the pitch presentation. The one or more questions may include requests for clarification, requests for additional information, requests for modifications or options, hypothetical situations, and/or any other question. In some of these embodiments, the VAC computer device 410 transmits the questions to a client device 405 of the representative, such as via an email, text notification, and/or push notification, for example.

After the pitch presentation, the VAC computer device 410 creates 235 recommendations based upon analysis of the vendor and the information presented in their pitch presentation. The VAC computer device 410 analyzes the vendor information to find matches for the strategy, attributes, desired goal outcomes, etc. Multiple vendors may be evaluated and the VAC computer device 410 may evaluate all and provide a prioritized list of recommendations.

In the exemplary embodiments, the VAC computer device 410 conducts 240 risk analysis and generates recommendations. The VAC computer device 410 may execute one or more GPT models be trained on risk elements to understand all risk exposures. The VAC computer device 410 may provide the GPT model information from the Internet, blockchains, and other sources of public data. The VAC computer device may even request data from the vendors that have been examined. This information may be requested through emails or other messages. The information could also be requested from vendor servers 425. After risk analysis, the VAC computer device 410 may generate and provide risk ratings and prioritized recommendations for the next steps of the process 200.

In the exemplary embodiment, the VAC computer device 410 receives 245 the decision makers acceptance of one of the recommendations. In some embodiments, if the decision maker does accept any of the recommendations, the VAC computer device 410 may return to step 225 and send out one or more additional meeting invites to other vendors for them to conduct pitch presentations. If one of the recommendations is accepted, then the VAC computer device 410 creates 250 an NDA, conducts negotiations, and generates contracts. In some embodiments, a company may decide to evaluate deeper with an NDA. The VAC computer device 410 would execute the trained GPT model to create the NDA. Then previous steps 230-240 would be repeated with information available once the NDA is signed. This loop may be conducted until the decision maker is satisfied. Once the decision maker is satisfied and the vendor accept decision is received in Step 245, the VAC computer device 410 begins contract negotiation.

In the exemplary embodiment, the VAC computer device 410 receives 255 an accept decision from the decision maker. In response to the accept decision from the decision maker, the VAC computer device 410 prepares 260 the contracts and payments. The VAC computer device 410 executes the GPT models to prepare 260 one or more contracts based upon the intended inventories needed, as well as, the strategies, goals, pricing, terms, uses, and other outcomes. The VAC computer device 410 shares the contracts with the vendor for negotiation. The VAC computer device 410 receives the vendor response(s) to the contracts. Then the VAC computer device 410 executes the GPT models to adjust the contract(s) based upon the response. The VAC computer device 410 repeat this process until all parties agree. Once agreement is reached, the VAC computer device coordinates bills of lading, contract signatures, and payment fulfillment. Once complete, the VAC computer device 410 also tracks end fulfillment. In some embodiments, the VAC computer device 410 analyzes each step of the process and provides a rating for the vendor based upon how well each step of the process was navigated and the vendor's willingness to negotiate.

In some further embodiments, the VAC computer system generates recommendations for future negotiations with a contracted vendor based upon one or more iterations of the negotiation process. Furthermore, the VAC computer system may also be able to provide feedback to the vendors who were declined. The feedback on the pitch presentation and/or bid may be provided for the vendor's own information and potential improvement. This feedback to the vendors may include information as to why a contract or negotiation was decline so that the vendors may make adaptations in the future. In some embodiments, this feedback may be specifically for systems where computer systems automate some or all of the approval process.

In additional embodiments, the VAC computer device 410 analyzes the results of contract negotiations that it conducted and analyzes the performance of the vendors associated with successful negotiations to retrain the GPT model(s). Furthermore, the VAC computer device 410 may analyze the performance of the vendors in providing the request goods and services to assist in further training of the GPT model(s) to determine potential warning signs about vendors that did not perform well and attributes of vendors that performed well and/or exceeded expectations.

### Exemplary Computer Process for Automated Vendor Analysis

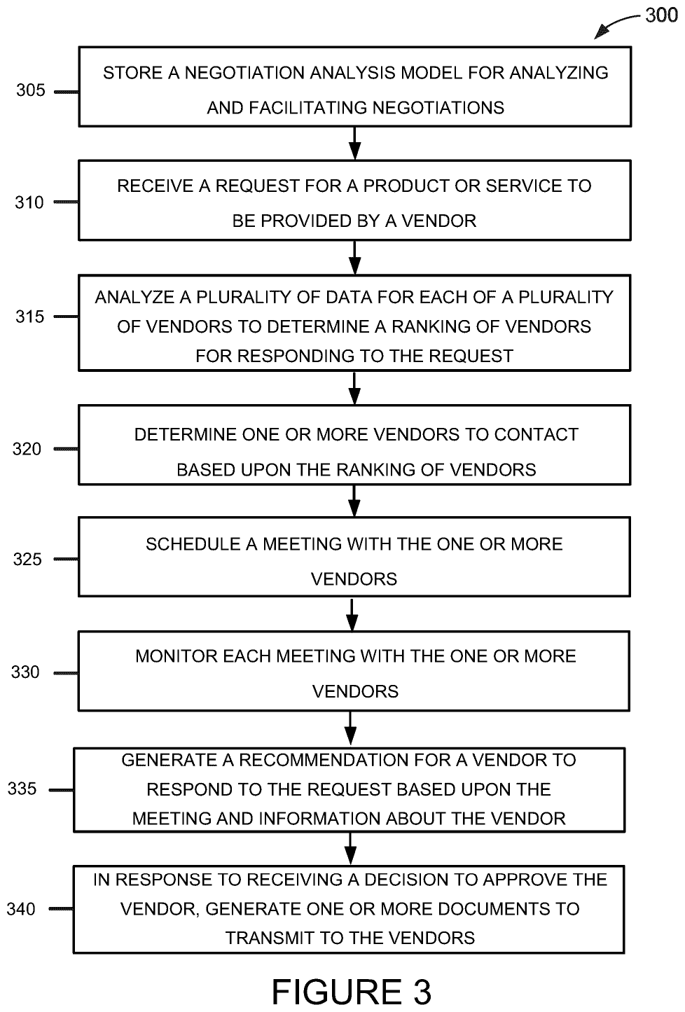

FIG. 3 illustrates a flow diagram of an exemplary computer-implemented process 300 for automated vendor negotiation and analysis, in accordance with at least one embodiment. In the exemplary embodiment, process 300 is performed by a vendor analysis and coordination (VAC) computer device 410 (shown in FIG. 4). In the exemplary embodiment, the VAC computer device 410 is in communication with at least one client device 405 and a plurality of vendor servers 425 (both shown in FIG. 4).

In the exemplary embodiment, the VAC computer device 410 stores 305 a negotiation analysis model for analyzing and facilitating negotiations. In the exemplary embodiment, the negotiation analysis model is a large language model, such as a GPT model. In some embodiments, the VAC computer device 410 stores 305 a plurality of GPT models, wherein the plurality of GPT models are configured for negotiating for different products or services and/or for different parts of the negotiation process as outlined herein. In some embodiments, the VAC computer device 410 stores a plurality of historical negotiation information about a plurality of past negotiations. The VAC computer device 410 trains the negotiation analysis model with the plurality of historical negotiation information.

In the exemplary embodiment, the VAC computer device 410 receives 310 a request for a product or service to be provided by a vendor. In some embodiments, the request includes information about at least one of goals, strategies, and outcomes for the product or service to be provided. In some further embodiments, the VAC computer device 410 analyzes one or more inventory levels of one or more products and generates the request for a product to be provided by the vendor based upon the one or more inventory levels. The one or more inventory levels may be stored in a blockchain structure.

In the exemplary embodiment, the VAC computer device 410 executes the negotiation analysis model to analyze 315 a plurality of data for each of a plurality of vendors to determine a ranking of vendors for responding to the request. The VAC computer device 410 receives the plurality of data about the plurality of vendors including a plurality of attributes of each of the plurality of vendors. The VAC computer device 410 may receive the plurality of data from a computer device associated with the vendor, such as a vendor server 425. The VAC computer device 410 may determine the ranking of vendors for responding to the request based upon how the corresponding vendor will meet the at least one of goals, strategies, and outcomes for the product or service to be provided.

In the exemplary embodiment, the VAC computer device 410 executes the negotiation analysis model to determine 320 one or more vendors to contact based upon the ranking of vendors.

In the exemplary embodiment, the VAC computer device 410 schedules (set-up) 325 a meeting with the one or more vendors. The VAC computer device 410 may schedule 325 the meeting with a first vendor of the one or more vendors by communicating with at computer device (e.g., vendor server 425) associated with the first vendor to determine a date for the meeting. The VAC computer device 410 may transmit a meeting invite to a first vendor for the meeting, such as via an application or email. In some embodiments, the VAC computer device 410 generates an invite to the meeting based upon the request.

In the exemplary embodiment, the VAC computer device 410 monitors 330 each meeting with the one or more vendors. In some embodiments, the VAC computer device 410 monitors a first meeting with a first vendor of the one or more vendors. While monitoring the first meeting, the VAC computer device 410 generates at least one question for the first vendor based upon the monitored first meeting. In some of these embodiments, the VAC computer device 410 may transmit the at least one question to a representative in the first meeting, such as via a client device 405 associated with the representative. In some further embodiments, the VAC computer device 410 may transmit the at least one question while the meeting is occurring.

In the exemplary embodiment, the VAC computer device 410 executes the negotiation analysis model to generate 335 a recommendation for a vendor to respond to the request based upon the meeting and information about the vendor.

In the exemplary embodiment, in response to receiving a decision to approve the vendor, the VAC computer device 410 generates 340 one or more documents to transmit to the vendor. In some embodiments, the one or more documents may include the VAC computer device 410 preparing a contract for the approved vendor to provide the product or service.

In some further embodiments, the VAC computer device 410 may monitor performance of a selected vendor providing the product or service. The VAC computer device 410 may analyze the performance of the selected vendor. Then the VAC computer device may update the negotiation analysis model based upon the analysis of the performance of the selected vendor.

In some further embodiments, the VAC computer device 410 may select the vendor to respond to the request based upon the meeting and information about the vendor.

In some further embodiments, the VAC computer device 410 may generate a non-disclosure agreement for a selected vendor. The VAC computer device 410 may submit the non-disclosure agreement to the selected vendor. And the VAC computer device 410 may receive an executed non-disclosure agreement from the selected vendor. The VAC computer device 410 may request private information from the selected vendor subsequent to receiving the executed non-disclosure agreement.

In some further embodiments, the VAC computer device 410 generates a feedback report for at least one unselected vendor. The feedback report includes information as to why the vendor was not selected. The feedback report may also include one or more improvements for the vendor for subsequent negotiations.

### Exemplary System

FIG. 4 illustrates an exemplary computer system 400 for performing the processes 100 and 200 (shown in FIGS. 1 and 2). In the exemplary embodiment, the system 400 is used for vendor negotiation and analysis.

As described below in more detail, the vendor analysis and coordination (VAC) computer device 410 may be programmed to for vendor negotiation and analysis. In addition, the VAC computer device 410 may be programmed to train large language models to be used negotiation aide and/or negotiators. In some embodiments, the VAC computer device 410 may be programmed to (1) store a negotiation analysis model for analyzing and facilitating negotiations; (2) receive a request for a product or service to be provided by a vendor; (3) execute the negotiation analysis model to analyze the plurality of information for each of the plurality of vendors to determine a ranking of vendors for responding to the request; (4) execute the negotiation model to determine one or more vendors to contact based upon the ranking of vendors; (5) schedule a meeting with the one or more vendors; (6) monitor each meeting with the one or more vendors; (7) execute the negotiation model to generate a recommendation for a vendor to respond to the request based upon the meeting and information about the vendor; and/or (8) in response to receiving a decision to approve the vendor, generate one or more documents to transmit to the vendor.

In the example embodiment, client devices 405 are computers that include a web browser or a software application, which enables client devices 405 to communicate with VAC computer device 410 using the Internet, a local area network (LAN), or a wide area network (WAN). In some embodiments, the client devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the VAC computer device 410 (also known as VAC server 410) is a computer that include a web browser or a software application, which enables VAC computer device 410 to communicate with client devices 405 using the Internet, a local area network (LAN), or a wide area network (WAN). In some embodiments, the VAC computer device 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. VAC computer device 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes one or more large language models and/or vendor information. In some embodiments, the database 420 is stored remotely from the VAC computer device 410. In some embodiments, the database 420 is decentralized. In the example embodiment, a person can access the database 420 via the client devices 405 by logging onto VAC computer device 410.

Vendor servers 425 may be any third-party server associated with a vendor that VAC computer device 410 is in communication with that provides additional functionality and/or information to VAC computer device 410. For example, vendor server 425 may provide current inventory and planned production information about the corresponding vendor. In the example embodiment, vendor servers 425 are computers that include a web browser or a software application, which enables vendor servers 425 to communicate with VAC computer device 410 using the Internet, a local area network (LAN), or a wide area network (WAN).

In some embodiments, the third-party servers 825 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Vendor servers 425 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Client Device

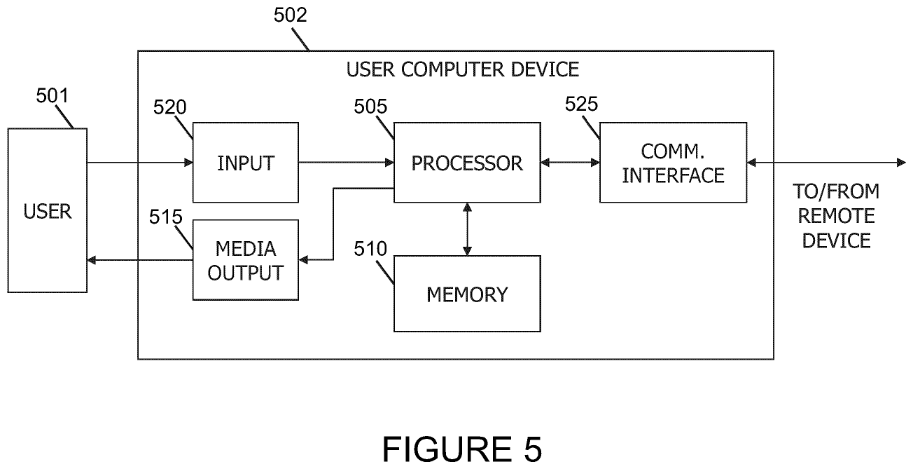

FIG. 5 depicts an exemplary configuration 500 of user computer device 502, in accordance with one embodiment of the present disclosure. In the exemplary embodiment, user computer device 502 may be similar to, or the same as, client device 405 (shown in FIG. 4). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the VAC computer device 410 (shown in FIG. 4). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as VAC computer device 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from VAC computer device 410. A client application may allow user 501 to interact with, for example, VAC computer device 410. For example, instructions may be stored by a cloud service, and the output of the execution of the instructions sent to the media output component 515.

### Exemplary Server Device

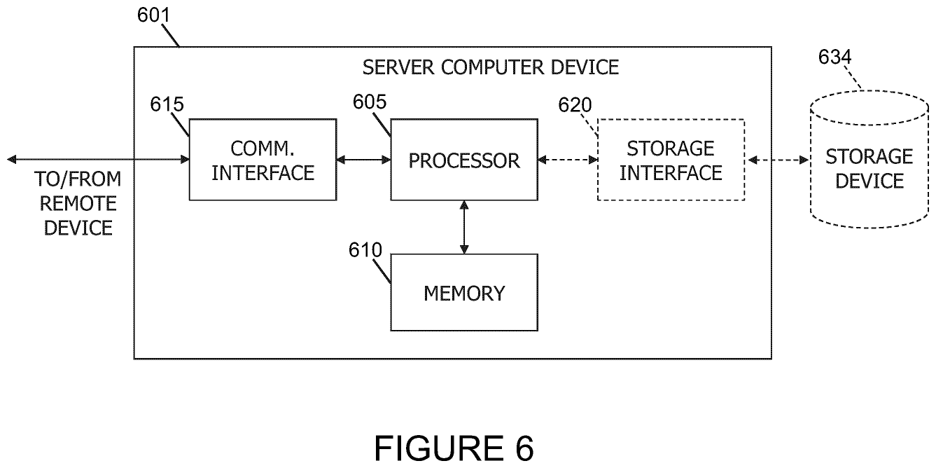

FIG. 6 depicts an exemplary configuration 600 of a server computer device 601, in accordance with one embodiment of the present disclosure. In the exemplary embodiment, server computer device 601 may be similar to, or the same as, VAC computer device 410, database server 415, and vendor server 425 (both shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, VAC computer device 410, vendor servers 425, and client devices 405 (shown in FIG. 4) (for example, using wireless communication or data transmission over one or more radio links or digital communication channels). For example, communication interface 615 may audio input from client devices 405 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with one or more models. In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 1 and 2.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, VAC computer device 410 is configured to implement machine learning, such that VAC computer device 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to identified objects, items classifications, textual product, and/or other data extracted from the images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different vendors, objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Exemplary Embodiments

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) store a negotiation analysis model for analyzing and facilitating negotiations; (2) receive a request for a product or service to be provided by a vendor; (3) execute the negotiation analysis model to analyze a plurality of data for each of a plurality of vendors to determine a ranking of vendors for responding to the request; (4) execute the negotiation analysis model to determine one or more vendors to contact based upon the ranking of vendors; (5) schedule a meeting with the one or more vendors; (6) monitor each meeting with the one or more vendors; (7) execute the negotiation analysis model to generate a recommendation for a vendor to respond to the request based upon the meeting and information about the vendor; and/or (8) in response to receiving a decision to approve the vendor, generate one or more documents to transmit to the vendor. The system may include additional, less, or alternate functionality, including that discussed elsewhere herein.

For example, an enhancement of the system may include a processor configured to receive the plurality of data about the plurality of vendors including a plurality of attributes of each of the plurality of vendors. The processor may also be configured to receive the plurality of data from a computer device associated with the vendor.

A further enhancement of the system may include a processor configured to store a plurality of historical negotiation information about a plurality of past negotiations. The system may also train the negotiation analysis model with the plurality of historical negotiation information.

A further enhancement of the system may include a processor configured to monitor a first meeting with a first vendor of the one or more vendors. The processor further configured to generate at least one question for the first vendor based upon the monitored first meeting. The processor also configured to transmit the at least one question to a representative in the first meeting. The processor may be configured to transmit the at least one question while the meeting is occurring.

A further enhancement of the system may include a processor configured to schedule a meeting with a first vendor of the one or more vendors by communicating with at computer device associated with the first vendor to determine a date for the meeting. The system may also transmit a meeting invite to a first vendor for the meeting. The system may further generate an invite to the meeting based upon the request.

A further enhancement of the system may be where the request includes information about at least one of goals, strategies, and outcomes for the product or service to be provided. The processor may be configured to determine the ranking of vendors for responding to the request based upon how the corresponding vendor will meet the at least one of goals, strategies, and outcomes for the product or service to be provided.

A further enhancement of the system may include a processor configured to monitor performance of a selected vendor providing the product or service. The system may also analyze the performance of the selected vendor. The system may further update the negotiation analysis model based upon the analysis of the performance of the selected vendor.

A further enhancement of the system may include a processor configured to select the vendor to respond to the request based upon the meeting and information about the vendor.

A further enhancement of the system may include a processor configured to generate a non-disclosure agreement for a selected vendor. The system may also submit the non-disclosure agreement to the selected vendor. The system may further receive an executed non-disclosure agreement from the selected vendor. In addition, the system may request private information from the selected vendor subsequent to receiving the executed non-disclosure agreement.

A further enhancement of the system may include a processor configured to prepare a contract for the approved vendor to provide the product or service.

A further enhancement of the system may include a processor configured to analyze one or more inventory levels of one or more products. The system may also generate the request for a product to be provided by the vendor based upon the one or more inventory levels. The information for the one or more inventory levels is stored in a blockchain structure.

A further enhancement of the system may include a processor configured to generate a feedback report for at least one unselected vendor. They feedback report may include information as to why the vendor was not selected. The feedback report may also include one or more improvements for the vendor for subsequent negotiations.

In another aspect, a computer-implemented method may be provided. The computer-implemented method may be performed by a computer device including at least one processor in communication with at least one memory device. The method may include: (1) storing a negotiation analysis model for analyzing and facilitating negotiations; (2) receiving a request for a product or service to be provided by a vendor; (3) executing the negotiation analysis model to analyze a plurality of data for each of a plurality of vendors to determine a ranking of vendors for responding to the request; (4) executing the negotiation analysis model to determine one or more vendors to contact based upon the ranking of vendors; (5) setting-up a meeting with the one or more vendors; (6) monitoring each meeting with the one or more vendors; (7) executing the negotiation analysis model to generate a recommendation for a vendor to respond to the request based upon the meeting and information about the vendor; and/or (8) in response to receiving a decision to approve the vendor, generating one or more documents to transmit to the vendor. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store a negotiation analysis model for analyzing and facilitating negotiations; (2) receive a request for a product or service to be provided by a vendor; (3) execute the negotiation analysis model to analyze a plurality of data for each of a plurality of vendors to determine a ranking of vendors for responding to the request; (4) execute the negotiation analysis model to determine one or more vendors to contact based upon the ranking of vendors; (5) schedule a meeting with the one or more vendors; (6) monitor each meeting with the one or more vendors; (7) execute the negotiation analysis model to generate a recommendation for a vendor to respond to the request based upon the meeting and information about the vendor; and/or (8) in response to receiving a decision to approve the vendor, generate one or more documents to transmit to the vendor. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for vendor negotiation and analysis, the computer system including at least one processor in communication with at least one memory device, the at least one processor programmed to:
store a negotiation analysis model for analyzing and facilitating negotiations;
receive a request for a product or service to be provided by a vendor;
execute the negotiation analysis model to analyze a plurality of data for each of a plurality of vendors to determine a ranking of vendors for responding to the request;
execute the negotiation analysis model to determine one or more vendors to contact based upon the ranking of vendors;
schedule a meeting with the one or more vendors;
monitor each meeting with the one or more vendors;
execute the negotiation analysis model to generate a recommendation for a vendor to respond to the request based upon the meeting and information about the vendor; and
in response to receiving a decision to approve the vendor, generate one or more documents to transmit to the vendor.

2. The computer system of claim 1, wherein the at least one processor is further programmed to receive the plurality of data about the plurality of vendors including a plurality of attributes of each of the plurality of vendors.

3. The computer system of claim 2, wherein the at least one processor is further programmed to receive the plurality of data from a computer device associated with the vendor.

4. The computer system of claim 1, wherein the at least one processor is further programmed to:
store a plurality of historical negotiation information about a plurality of past negotiations; and
train the negotiation analysis model with the plurality of historical negotiation information.

5. The computer system of claim 1, wherein the at least one processor is further programmed to:
monitor a first meeting with a first vendor of the one or more vendors; and
generate at least one question for the first vendor based upon the monitored first meeting.

6. The computer system of claim 5, wherein the at least one processor is further programmed to transmit the at least one question to a representative in the first meeting.

7. The computer system of claim 6, wherein the at least one processor is further programmed to transmit the at least one question while the meeting is occurring.

8. The computer system of claim 1, wherein the at least one processor is further programmed to schedule a meeting with a first vendor of the one or more vendors by communicating with at computer device associated with the first vendor to determine a date for the meeting.

9. The computer system of claim 1, wherein the at least one processor is further programmed to transmit a meeting invite to a first vendor for the meeting.

10. The computer system of claim 1, wherein the at least one processor is further programmed to generate an invite to the meeting based upon the request.

11. The computer system of claim 1, wherein the request includes information about at least one of goals, strategies, and outcomes for the product or service to be provided, and wherein the at least one processor is further programmed to determine the ranking of vendors for responding to the request based upon how the corresponding vendor will meet the at least one of goals, strategies, and outcomes for the product or service to be provided.

12. The computer system of claim 1, wherein the at least one processor is further programmed to:
monitor performance of a selected vendor providing the product or service;
analyze the performance of the selected vendor; and
update the negotiation analysis model based upon the analysis of the performance of the selected vendor.

13. The computer system of claim 1, wherein the at least one processor is further programmed to select the vendor to respond to the request based upon the meeting and information about the vendor.

14. The computer system of claim 1, wherein the at least one processor is further programmed to:
generate a non-disclosure agreement for a selected vendor;
submit the non-disclosure agreement to the selected vendor; and
receive an executed non-disclosure agreement from the selected vendor.

15. The computer system of claim 14, wherein the at least one processor is further programmed to request private information from the selected vendor subsequent to receiving the executed non-disclosure agreement.

16. The computer system of claim 1, wherein the at least one processor is further programmed to prepare a contract for the approved vendor to provide the product or service.

17. The computer system of claim 1, wherein the at least one processor is further programmed to:
analyze one or more inventory levels of one or more products; and
generate the request for a product to be provided by the vendor based upon the one or more inventory levels.

18. The computer system of claim 17, wherein information for the one or more inventory levels is stored in a blockchain structure.

19. The computer system of claim 1, wherein the at least one processor is further programmed to generate a feedback report for at least one unselected vendor, wherein the feedback report includes information as to why the vendor was not selected.

20. The computer system of claim 19, wherein the feedback report includes one or more improvements for the vendor for subsequent negotiations.

21. A computer-implemented method of vendor negotiation and analysis, the method implemented by a computer system including at least one processor in communication with at least one memory device, the method comprises:
storing a negotiation analysis model for analyzing and facilitating negotiations;
receiving a request for a product or service to be provided by a vendor;
executing the negotiation analysis model to analyze a plurality of data for each of a plurality of vendors to determine a ranking of vendors for responding to the request;
executing the negotiation analysis model to determine one or more vendors to contact based upon the ranking of vendors;
setting-up a meeting with the one or more vendors;
monitoring each meeting with the one or more vendors;
executing the negotiation analysis model to generate a recommendation for a vendor to respond to the request based upon the meeting and information about the vendor; and
in response to receiving a decision to approve the vendor, generating one or more documents to transmit to the vendor.

22. At least one non-transitory computer-readable storage media having computer-executable instructions embodied thereon, wherein when executed by at least one processor of a computer system, the computer-executable instructions cause the processor to:
store a negotiation analysis model for analyzing and facilitating negotiations;
receive a request for a product or service to be provided by a vendor;
execute the negotiation analysis model to analyze a plurality of data for each of a plurality of vendors to determine a ranking of vendors for responding to the request;
execute the negotiation analysis model to determine one or more vendors to contact based upon the ranking of vendors;
schedule a meeting with the one or more vendors;
monitor each meeting with the one or more vendors;
execute the negotiation analysis model to generate a recommendation for a vendor to respond to the request based upon the meeting and information about the vendor; and
in response to receiving a decision to approve the vendor, generate one or more documents to transmit to the vendor.
